(19) United States
(12) Patent Application Publication
(10) Pub. No.: US 2009/0074286 A1
(43) Pub. Date: Mar. 19, 2009

(54) DATA MANAGEMENT EQUIPMENT USED TO DEFECT REVIEW EQUIPMENT AND TESTING SYSTEM CONFIGURATIONS

(75) Inventors: Masahiro KITAZAWA, Honjo (JP); Mitsuji Ikeda, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/205,419

(22) Filed: Sep. 5, 2008

(30) Foreign Application Priority Data
Sep. 14, 2007 (JP) 2007-239408

(51) Int. Cl. G06K 9/00

(52) U.S. Cl. 382/144

(57) ABSTRACT

A data management equipment connected with a general inspection system for detecting a defect candidate on a wafer and acquiring a location thereof, a design data server for storing a design data for a semiconductor circuit and a defect review system for acquiring a defect data image on the basis of the location and comparing the defect candidate image with a defect-free reference image to identify a defect. The data management equipment includes a first detecting unit for finding that the general inspection system is acquiring a location, a storage controlling unit responsive to the finding to start to store the location from the general inspection system in a storage unit and a defect-circumferential design data acquiring unit for acquiring from a portion of the design data a defect-circumferential design data such that a reference image including the location can be produced from the defect-circumferential design data.

### BACKGROUND OF THE INVENTION

The present invention relates to defect review systems for identifying a plurality of defects on a wafer or an exposure mask used in the manufacturing of semiconductor circuits. The invention also relates to testing systems including such defect review system and to data management equipments connected with such defect review system.

In the field of semiconductor circuits, the selling prices are being made lower, diversified small-quantity production is being promoted, and shorter time limit of delivery is being encouraged. Accordingly, it is now required in the process of manufacturing semiconductor circuits to enhance the production yield and to reduce the chip size by the use of the fine patterning techniques for reduction of the production cost. To this end, defects such as disconnection, shorts and contamination by foreign materials are discovered in respective manufacturing steps, and countermeasures have been developed against them.

Actually, however, the fine patterning is escalated for semiconductor circuits to increase the number of devices to be incorporated into each semiconductor circuit, and sizes of disconnected areas, shorted areas and foreign materials become smaller to increase inspection time necessary for discovering defects. Such increase of inspection time entails an increase of the production cost, and therefore, it is required to be reduced.

### SUMMARY OF THE INVENTION

Inspection to discover defects may involve the following. First, a wafer surface inspection system is used to inspect a semiconductor wafer having thereon semiconductor circuits to detect a defect candidate location of a defect candidate which is considered to be a candidate for a defect on the wafer. Next, an automated defect review system is used to image an area including the defect candidate location at a low magnification to acquire a defect candidate image. The defect candidate image is compared with a defect-free reference image to specify a correct defect location so that a defect is imaged at a high magnification by using information on the correct defect location to acquire a defect image. Finally, the defect image at a high magnification is observed through an approach called “review”, in which factors causing defects are analyzed and the defects are classified for each factor, thereby identifying the defects.

As to related prior art: for a method of acquiring a defect image, it is proposed to make use of a scanning electron microscope (see, for example, JP-A-2000-30652); a defect review system is proposed in which a synthesized reference image free of defect is generated from a defect candidate image of a low magnification to reduce the number of times of imaging thereby shortening an inspection time (see, for example, JP-A-2007-40910); and an inspection system is proposed which includes a navigation system having design data for a semiconductor circuit such as CAD data stored therein and establishing, on the basis of the design data, imaging/inspection conditions including areas of a semiconductor wafer to be inspected and includes a scanning electron microscope carrying out size measurement/inspection (see, for example, JP-A-2002-328015).

With the above prior art, when a defect candidate image of a low magnification is compared with a reference image to specify a correct defect location of a defect, it may take place that a particular pattern in a semiconductor circuit may be erroneously recognized as a defect for imaging at a high magnification with a result that, in the reviewing process, the “defect” on the defect image is finally determined as not a true defect.

To prevent a particular pattern in a semiconductor circuit from being erroneously recognized as a defect, use has been made of design data for a semiconductor circuit. However, the design data is so voluminous or big that retrieval of necessary data takes a long time, which may lead to a long inspection time.

An object of the present invention is to provide a data management equipment which enjoys a short inspection time even when a design data for a semiconductor circuit is utilized.

Another object of the invention is to provide a testing system which enjoys a short inspection time.

Another object of the invention is to provide a defect review system which enjoys a short inspection time.

According to an aspect of the present invention, there is provided a data management equipment connected with a general inspection system for detecting a plurality of defect candidates on a wafer or an exposure mask used for manufacturing a semiconductor circuit and acquiring locations (of defect candidates) at which the defect candidates are located, a design data server for storing therein design data for the semiconductor circuit and a defect review system for imaging the defect candidates on the basis of the locations (of the defect candidates) to acquire defect candidate images and for comparing the defect candidate images with defect-free reference images to identify defects, in which the data management equipment includes:

a first detecting unit for finding that the general inspection system is acquiring the locations (of the defect candidates);

a storage controlling unit responsive to the finding by the first detecting unit to start to store locations (of the defect candidates) from the general inspection system in a storage unit; and

defect-circumferential design data acquiring unit for acquiring defect-circumferential design data from portions of the design data, the defect-circumferential design data being such that reference images can be produced from the defect-circumferential design data, the produced reference images containing the locations (of the defect candidates), the storage controlling unit serving to store the defect-circumferential design data in the storage unit in such a manner that the defect-circumferential design data are related to corresponding locations (of the defect candidates) for each defect candidate.

According to another aspect of the present invention, there is provided a testing system having the above-described data management equipment.

According to another aspect of the present invention, there is provided a defect review system having the above-described data management equipment.

In accordance with one or more of the above aspects of the present invention, the data management equipment, the testing system and/or the defect review system enjoy shortened inspection time even when use is made of semiconductor design data.

Other objects, features and advantages of the invention will become apparent from the following description of the embodiments of the invention taken in conjunction with the accompanying drawings.

### BRIEF DESCRIPTION OF THE DRAWINGS

FIG. 1A is a structural diagram of a testing system according to an embodiment of the present invention.

FIG. 1B is a structural diagram of a data management equipment according to an embodiment of the present invention.

FIG. 2 is a flow chart illustrating a flow of processing steps in a testing system according to an embodiment of the present invention.

FIG. 3A is a diagram showing a GUI display screen of a data management equipment according to an embodiment of the present invention.

FIG. 3B is a diagram showing a state in which a defect candidate image and a pseudo-reference image are superimposed onto each other.

FIG. 3C is a representation of defect-circumferential design data.

FIG. 3D is a diagram showing a table of check modes contained in a check mode tag.

FIG. 3E is a diagram showing a table of data items for a defect candidate.

FIG. 4A is a diagram of a design pattern for a semiconductor circuit.

FIG. 4B is a diagram showing defect-circumferential design data.

FIG. 5 is a flow chart illustrating a defect detecting method employed in a defect review system which is a comparison example.

FIG. 6 is a flow chart illustrating a defect detecting method employed in a defect review system included in a testing system according to an embodiment of the present invention.

FIG. 7A is a diagram of a defect candidate image.

FIG. 7B is a diagram of a synthesized reference image.

FIG. 7C is a diagram of an image representative of a difference between the defect candidate image and the synthesized reference image.

FIG. 7D is a diagram of a design pattern.

FIG. 7E is a diagram of an image representative of a difference between the defect candidate image and the design pattern.

FIG. 8A is a diagram of another defect candidate image.

FIG. 8B is a diagram of a pseudo-reference image.

FIG. 8C is a diagram of an image representative of a difference between the another defect candidate image and the pseudo-reference image.

FIG. 9A is a diagram of another design pattern for a semiconductor circuit.

FIG. 9B is a diagram of design pattern parts of an identical shape contained in a defect-circumferential design pattern.

FIG. 9C is a diagram of design pattern parts of different shapes contained in a defect-circumferential design pattern.

FIG. 9D is a diagram of design pattern parts of an identical shape in a periodic array contained in a defect-circumferential design pattern.

FIG. 10 is a flow chart illustrating how the data management equipment carries out selection from two check modes, a die-to-die comparison and a cell comparison, so that the defect review system follows the selected check mode for defect inspection.

### DESCRIPTION OF THE EMBODIMENTS

Embodiments of the present invention will now be described in detail with reference to the accompanying drawings. In the drawings, same reference numerals are used to denote similar members and explanation of the similar members will not be repeated.

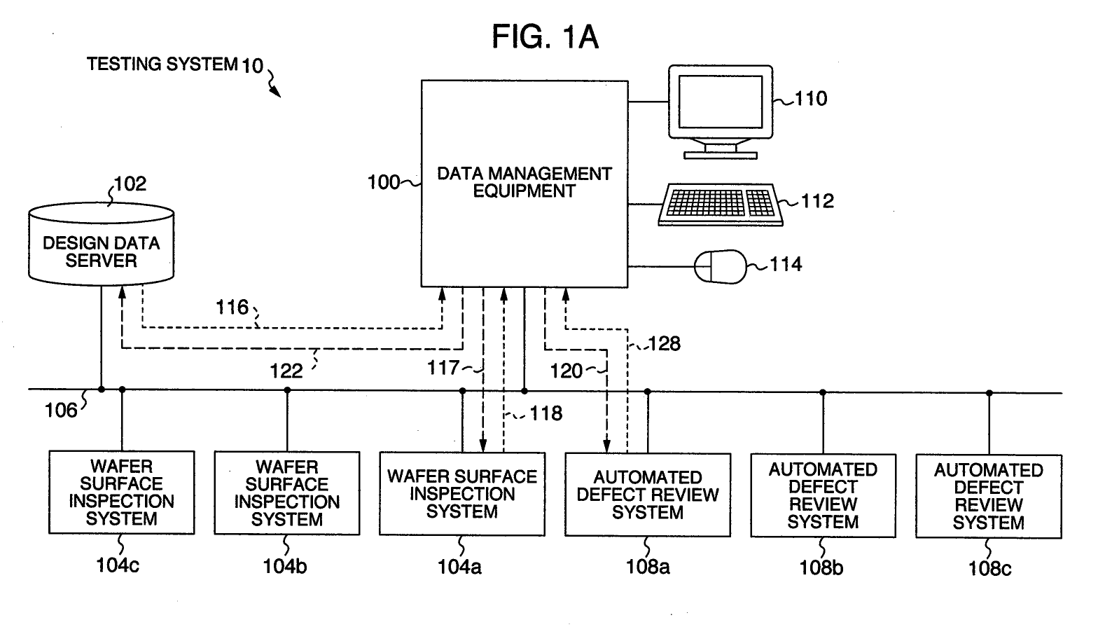

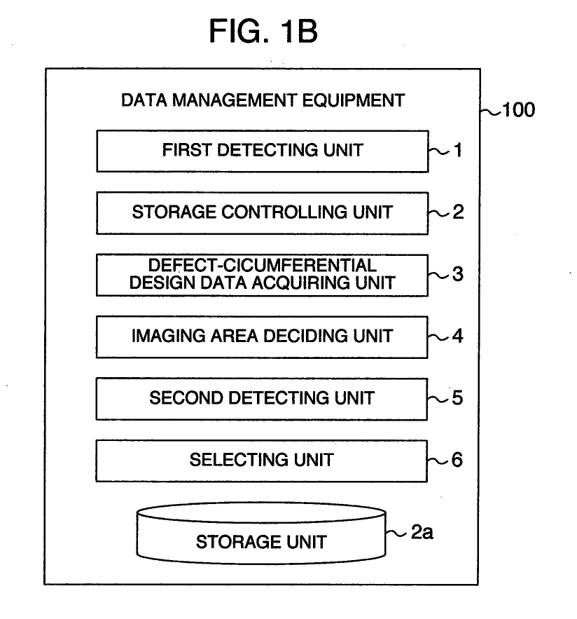

FIG. 1A is a structural diagram of a testing system 10 according to an embodiment of the present invention. A data management equipment 100, plural (automated) defect review systems 108a, 108b and 108c, a design data server 102, and plural general inspection systems or plural (wafer surface) inspection systems 104a, 104b and 104c are connected with one another through a network 106.

Each of the general inspection systems 104a, 104b and 104c detects candidates for defects on a wafer or an exposure mask used to manufacture semiconductor circuits and acquires a defect candidate location of each of the detected defect candidates. The inspection system 104a acquires a size of each of the defect candidates in accordance with the defect candidate locations of the defect candidates.

The design server 102 stores therein design data for semiconductor circuits.

Each of the defect review systems 108a, 108b and 108c images the above-mentioned defect candidates on the basis of the defect candidate locations to acquire defect candidate images and compare them with defect-free reference images to correctly specify locations of defects. Based on the thus specified defect locations, the defect review systems image the defects at high magnifications to acquire defect images. The defect review systems then make observations, called “review”, of the defect images to analyze causes of occurrence of the defects and classify the defects with respect to the causes so that the defects are identified.

The data management equipment 100 always searches (117) the inspection systems 104a to 104c, and, whenever the inspection systems 104a to 104c produce defect candidate information (118), which includes defect candidate locations of defect candidates, the equipment 100 immediately acquires the defect candidate information 118. The equipment 100 further sends readout request information 122 to the design data server 102 so that defect-circumferential design data 116 including data at and around a location of a defect candidate is solely extracted and read out from the design data of the semiconductor circuits.

Since the design data of the semiconductor circuits are so big that it may take rather a long time to extract the defect-circumferential design data 116 in the design data server 102. However, during the time in which the defect-circumferential design data 116 is extracted in the design data server 102, the inspection in the defect review system 108a has not been started yet, and therefore, there will be no fear of prolongation of time necessary for inspection by the defect review system 108a. Further, since the extracted defect-circumferential design data 116 is small, use of the data 116 for inspection in the defect review system 108a will not result in an inspection time longer than that without using the data 116.

To describe more specifically, in the process of manufacturing semiconductor circuits, ten wafers or so are grouped into a lot so that wafers are placed into carrier cases lot by lot for transfer from one manufacturing step to another. The same applies to transfer in the inspection equipment 104a and the defect review system 108a. Thus, a lot remains in the inspection equipment 104a until inspection of all of the wafers of the lot has been completed. After completion of the inspection of all of the wafers of the lot, the lot as placed into the carrier case is moved via a transfer unit from the inspection equipment 104a to the defect review system 108a. The reviewing in the defect review system 108a will not start until the lot is captured by the system 108a.

Conventionally, therefore, the defect candidate information 118 is also moved in the unit of lot, along with the movement of a lot of wafers, from the inspection equipment 104a to the defect review system 108a. The defect review system 108a uses the defect candidate information 118 thus moved in the unit of lot to extract the defect-circumferential design data 116, with a result that inspection by the use of the defect-circumferential design data needs a long time. To describe the movement of the defect candidate information 118 in more detail, in the inspection equipment 104a, for example, the defect candidate information 118 for a wafer in a lot which is first subjected to inspection will be kept staying in the equipment 104a until inspection of all of the wafers of the lot has been completed.

In the described embodiment of the present invention, the data management equipment 100 always searches (117) the inspection systems 104a to 104c so that, when the systems 104a to 104c produce defect candidate information 118 including defect candidate locations of defect candidates, the data management equipment 100 immediately acquires the defect candidate information 118, not in the unit of lot, but in the unit of wafer, or in the unit of chip (semiconductor circuit) as the case demands. Thus, to acquire the defect candidate information, there is not need to wait until completion of the inspection of the whole lot in the inspection system 104a. For example, the candidate information 118 from a wafer first inspected in a lot in the inspection system 104a is acquired by the data management equipment 100 while a second wafer or a subsequent wafer is being inspected in the inspection system 104a so that the data management equipment 100 performs an extraction of the defect-circumferential design data 116.

Further, an extraction of the defect-circumferential design data 116 by use of the defect candidate information 118 from a wafer last inspected in a lot in the inspection system 104a may be carried out while the lot is moved from the inspection system 104a to the defect review system 108a and/or while a wafer in the lot other than that which is last reviewed in the lot is reviewed in the defect review system 108a. Accordingly, in the described embodiment in which use is made of the defect-circumferential design data 116 to test wafers or exposure masks, neither the inspection time in the inspection system 104a nor the reviewing time in the defect review system 108a is not longer than those in a case in which the defect-circumferential design data 116 is not used.

The defect-circumferential design data 116 read out is stored in the data management equipment 100. The equipment 100 is responsive to a readout request information 128 from the defect review system 108a to send thereto defect capturing information 120 including a defect candidate location and a defect-circumferential design data. The defect review system 108a performs a reviewing operation on the basis of the defect capturing information 120 to identify a defect. Since the review in the defect review system 108a utilizes the defect-circumferential design data, it is possible to suppress failures in which a particular pattern part in a semiconductor circuit such as a bent or curved portion is erroneously recognized as a defect.

The data management equipment 100 is provided with a GUI for facilitating input/output operations by a user. To implement the GUI, a display 110, a keyboard 112 and a mouse 114 are provided.

Although the data management equipment 100 is illustrated as being separate from the defect review system 108a in FIG. 1A, the arrangement is not restricted thereto, and the defect review system 108a may encompass the data management equipment 100.

FIG. 1B is a structural diagram of a data management equipment 100 according to an embodiment of the present invention. The data management equipment 100 includes a first detecting unit 1, a storage controlling unit 2, defect-circumferential design data acquiring unit 3, an imaging area deciding unit 4, a second detecting unit 5 and a selecting unit 6.

The first detecting unit 1 serves to find that the inspection system 104a is acquiring the defect candidate locations.

The storage controlling unit 2 is responsive to the finding by the first detecting unit 1 to start to store the defect candidate locations from the inspection system 104a. The storage controlling unit 2 stores, in a storage unit 2a, defect candidate locations on a plurality of wafers or exposure masks and defect-circumferential design data from a plurality of inspection systems 104a, 104b and 104c. The storage controlling unit 2 further reads out, from the storage unit 2a to a plurality of defect review systems 108a, 108b and 108c, defect candidate locations and defect-circumferential design data for each of the plurality of wafers or exposure masks having been captured.

The defect-circumferential design data acquiring unit 3 acquires defect-circumferential design data from a portion of the design data. The defect-circumferential design data is such that a reference image containing a defect candidate location, as described above, can be produced from the defect-circumferential design data.

The storage controlling unit 2 stores defect-circumferential design data in the storage unit 2a in such a manner that the defect-circumferential design data are related to their corresponding defect candidate locations for each of the defect candidates. When the storage controlling unit 2 reads out a defect-circumferential design data and a defect candidate location from the storage unit 2a to the defect review system 108a, the system 108a acquires a reference image on the basis of the defect-circumferential design data and defect candidate location.

Since the inspection system 104a is to acquire information on the size of each of the defect candidates for the defect candidate locations, the imaging area deciding unit 4 decides, on the basis of information on the sizes, boundaries of areas on the wafer to be imaged for the defect candidates. The field of the reference image is established to have a boundary coincident with that of an area to be imaged for providing a defect candidate image to thereby facilitate comparison between them.

The second detecting unit 5 serves to find that the defect review system 108a has captured a wafer or an exposure mask. Since a reviewing operation in the defect review system 108a is now possible, the storage controlling unit 2, in response to the finding by the second detecting unit 5, starts to read out of defect-circumferential design data and defect candidate locations to the defect review system 108a.

The selecting unit 6 serves to select, on the basis of the defect-circumferential design data, one of the die-to-die comparison and the cell comparison to be employed for carrying out a comparison between a defect candidate image and a reference image in the defect review system 108a. The selection by the selecting unit 6 is performed through a determination as to whether or not the defect-circumferential design data defines a plurality of pattern parts of an identical shape or whether or not the defect-circumferential design data defines a plurality of pattern parts of an identical shape recurrent with a periodicity.

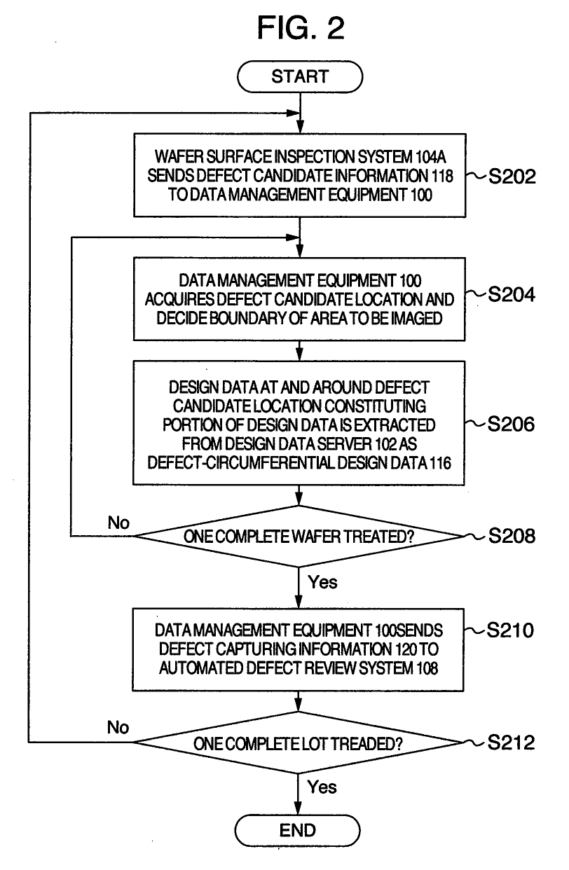

FIG. 2 is a flow chart illustrating a flow of processing steps in a testing system 10 according to an embodiment of the present invention.

First, the inspection system 104a inspects a lot constituted by a plurality of wafers. The first detecting unit 1 acquires from the inspection system 104a a status of the inspection system 104a at a fixed period. When the status indicates that an inspection is being performed, the first detecting unit 1 acquires a lot ID of a lot under inspection, a title of inspection step and a number of wafers constituting the lot. The first detecting unit 1 then determines whether the storage unit 2a has stored a defect capturing information 120 related to a lot ID and a title of inspection step identical with those mentioned above. If it is stored in the storage unit 2a, the process returns to a status acquiring step, while, if not, the first detecting unit 1 sends an information request signal to the inspection system 104a.s

In step S202, the inspection system 104a, upon receipt of the information request signal, sends to the data management equipment 100 a defect candidate information 118 related to the lot ID, the title of inspection step and the wafer ID for each wafer. The defect candidate information includes a location of a defect candidate on a wafer (a defect candidate location), an ID of the defect candidate, a size of the defect candidate, an ID of a chip (a semiconductor circuit) (i.e., a row number of the chip CHIP X and a column number of the chip CHIP Y on the wafer).

In step S204, the storage controlling unit 2 receives the defect candidate information 118 for each chip, and stores it in the storage unit 2a in relation to the lot ID, the title of inspection step and the wafer ID.

In step S204, the imaging area deciding unit 4 extracts, on the basis of the lot ID and the title of inspection step, a title of semiconductor circuit corresponding to the lot ID, and extracts a design data on the basis of the extracted title of semiconductor circuit and the title of inspection step, and extracts line and space design rules on the basis of the extracted design data. The imaging area deciding unit 4 further decides a magnification at which the defect review system 108a is to carry out a low magnification imaging of the defect candidate and decides a number of pixels for a defect candidate image to be produced. For this decision, use may be made of a magnification/number of pixels database which establishes the magnification and the number of pixels in such a manner that the magnification is lower and the number of pixels is larger as the size of the defect candidate is larger and the design rules are stricter. The imaging area deciding unit 4 then decides, on the basis of information on the magnification and the number of pixels, a boundary of an area on the wafer to be imaged by the defect review system 108a for providing a defect candidate image.

In step S206, the defect-circumferential design data acquiring unit 3 specifies, on the basis of the lot ID and the title of inspection step, design data for a corresponding layer of a corresponding semiconductor circuit in the design data server 102. The defect-circumferential design data acquiring unit 3 then extracts a portion of the design data from the design data server 102 and produces therefrom a defect-circumferential design data 116, the portion of the design data to be extracted being determined to cover an area larger than that with which a defect candidate is imaged and being determined to include the location of the defect candidate. The defect-circumferential design data acquiring unit 3 further receives a defect-circumferential design data 116 from the design data server 102 via the network 106.

The storage controlling unit 2 relates the defect-circumferential design data 116 to a defect candidate ID and stores it in the storage unit 2a. The storage controlling unit 2 produces, in the storage unit 2a, a defect capturing information 120 including the defect-circumferential design data 116 and the defect candidate information 118. The respective constituent elements of the defect capturing information 120 including the defect-circumferential design data 116 and the defect candidate information 118 is related to one another through a defect candidate ID.

In step S208, the defect-circumferential design data acquiring unit 3 determines whether or not the defect-circumferential design data have been acquired for all of the defect candidates on a wafer. If so (Yes in step S208), the process proceeds to step S210, while if not (No in step S208), the process returns to step S204.

In step S210, the second detecting unit 5 acquires from the defective review system 108a its status at a fixed period. When the status indicates that a lot is being captured, the second detecting unit 5 acquires a lot ID and a title of reviewing step of the lot from the defective review system 108a. The second detecting unit 5 further extracts from the storage unit 2a a defect capturing information 120 related to the lot ID and the title of reviewing step thus acquired and sends it to the defect review system 108a. The defect review system 108a reviews a wafer by using the defect capturing information 120. In this connection, if the defect review system 108a has a sufficient storage capacity, the defect capturing information 120 may be, upon production, unconditionally sent thereto from the data management equipment 100, without waiting for the capturing of a lot.

Lastly, in step S212, the second detecting unit 5 determines whether or not the number of wafers for which the defect capturing information 120 have been sent to the defect review system 108a amounts to a number of wafers constituting a lot. Thereby, it is possible to determine whether or not a process for one lot in the data management equipment 100 has been completed. If the number of wafers has been reached (Yes in step (S121), the process for one lot ends. If the number of wafers has not been reached (No in step (S212), the process for one lot does not end and returns to step S202 to repeat the steps S202 to S210 until the number of wafers is reached.

The defect review system 108a images a defect candidate at a low magnification in accordance with the defect capturing information 120 to detect true defects and classify them. The sending of defect capturing information 120 from the data management equipment 100 to the defect review system 108a need not be always performed wafer by wafer, and may be performed for each defect candidate if the defect capturing information 120 has not yet been produced for one complete wafer by the time when a reviewing in the defect review system 108a starts. On the contrary, if the defect capturing information 120 has already been produced for one lot of wafers by the reviewing start time, the information 120 may be sent lot by lot.

The defect review system 108a sends to the storage unit 102a of the data management equipment 100 a defect candidate image obtained by imaging a defect candidate on a wafer as described. The storage controlling unit 2 relates the defect capturing information 120 to the defect candidate images for each defect candidate and stores them in the storage unit 2a. The operator compares a design pattern produced on the basis of the defect-circumferential design data with a defect candidate image through the GUI, thereby confirming that the defect review system 108a accomplishes its defect detecting operation normally.

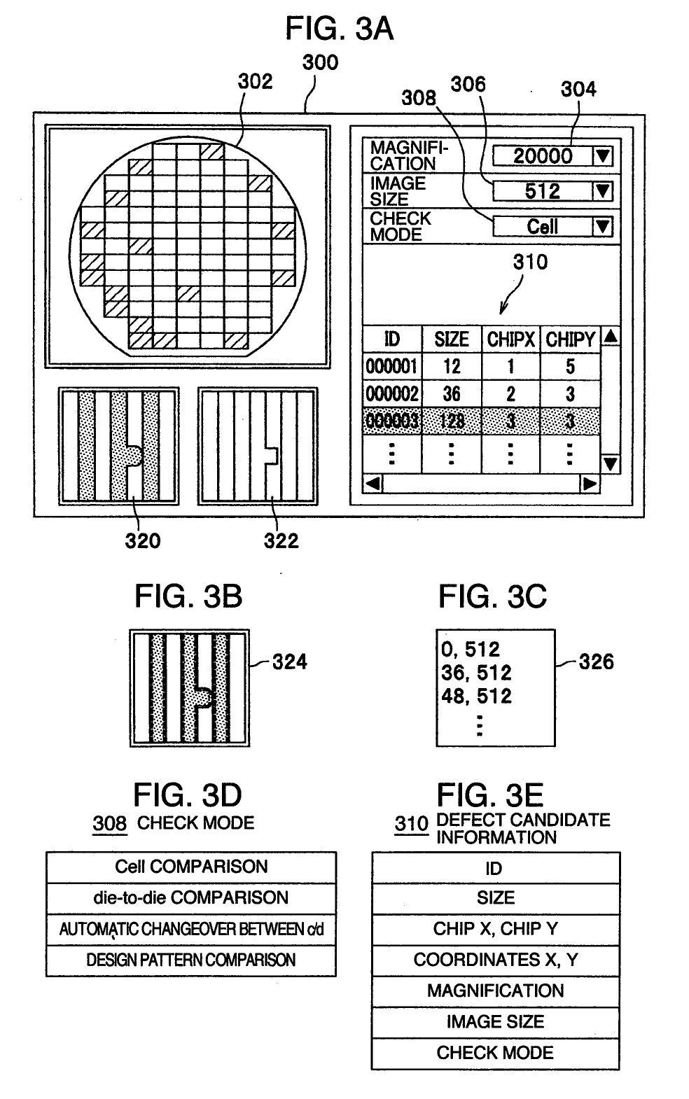

FIG. 3A is a diagram showing a GUI display screen 300 of a data management equipment 100 according to an embodiment of the present invention. The GUI display screen 300 functions to display, at a defect candidate information 310 (corresponding to that represented by 118 in FIG. 1A), an ID of defect candidate (ID), a size of defect candidate (SIZE), a column number (CHIP X) and a row number (CHIP Y) of a chip (semiconductor circuit) containing a defect, and others, in the form of a table. Further, as shown in FIG. 3E, the GUI display screen 300 functions to display, at the defect candidate information 310, coordinates X and Y of defect candidate on wafer (defect candidate location), a magnification at which a defect candidate is to be imaged to provide a defect candidate image, an image size for imaging (number of pixels), a check mode for use in comparison between a defect candidate image and a reference image, and others, in the form of a table.

The GUI display screen 300 further provides a chip location chart 302 having a shape similar to a wafer which allows the operator to learn a location on the wafer of a chip containing a defect.

The data management equipment 100 manages defect candidate images produced by the defect review system 108a so that the operator selects one of the rows corresponding to a defect candidate under consideration (ID 000003 in FIG. 3A) in the defect candidate information 310 by inverting that one row and visually compares a defect candidate image 320 of the defect candidate under consideration and a design pattern 322 produced from the defect-circumferential design data corresponding to the defect candidate under consideration.

With the GUI display screen 300, as shown in FIG. 3B, it is also possible to generate a superimposition chart 324 of the defect candidate image 320 and the design pattern 322. By the visual comparison and the generation of the superimposition chart 324, it is possible to confirm that the defect review system 108a performs its defect detecting operation normally.

Further with the GUI display screen 300, as shown in FIG. 3C, it is also possible to provide a text representation 326 of numerical information on line segments on which the design pattern 322 of the defect-circumferential design data is based.

By using the GUI, the operator can designate a magnification at which the defect review system 108a images a defect candidate to provide a defect candidate image, a size of image to be produced (a number of pixels), a check mode to be used to compare a defect candidate image and a reference image. To designate a magnification for the imaging by the defect review system 108a, in the defect candidate information 310, a row corresponding to a defect candidate under consideration should be first inverted for selection, and thereafter, an intended magnification should be selected by a magnification tab 304. To designate a number of pixels for an image to be produced by the defect review system 108a, after selection of a defect candidate in a similar manner, an intended number of pixels should be selected by an image size tab 306. To designate a check mode for use in comparison, after selection of a defect candidate in a similar manner, an intended check mode should be selected by a check mode tab 308.

For a check mode to be used in comparison, a selection is possible, for each defect candidate, from cell comparison, die-to-die comparison, automatic switchover between C/D and design pattern comparison, as shown in FIG. 3D. The cell comparison is a check mode useful when a defect candidate image contains recurrent pattern parts called cells. The die-to-die comparison is a check mode useful when a defect candidate image does not contain such recurrent pattern parts. The automatic switchover between C/D to be described in detail later is a check mode in which a defect candidate image is analyzed for each defect candidate to determine which of the cell comparison and the die-to-die comparison should be employed. The design pattern comparison is a check mode in which defect-circumferential design data is used to produce a reference image.

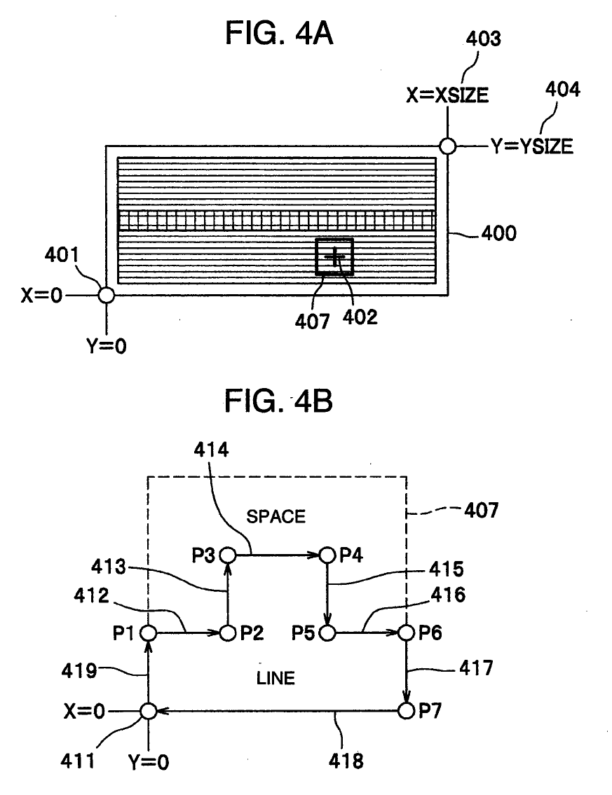

FIG. 4A shows a design pattern produced from the design data for a certain layer in a semiconductor circuit. The design data includes a representation of line segments in the design pattern for a semiconductor circuit in the form of X and Y coordinates of start and end points of the line segments. The design pattern is represented by a set of line segments. Each line segment is defined by X and Y coordinates of a start point and those of an end point. It is assumed in FIG. 4A that the lower left point is the origin (401) for the design data (X=0 and Y=0), and that the chip of the semiconductor circuit 400 has a X-direction chip size 403 (X=X SIZE) as its lateral length and a Y-direction size 404 (Y=Y SIZE) as its longitudinal length. A defect candidate location of a defect candidate is marked “+”. The design pattern 407 corresponding to the defect-circumferential design data 116 may be demarcated by a square having at its center a defect candidate location 402. The sizes of the square are determined by the magnification for imaging which can be set by the magnification tab 304 on the GUI display screen 300 and the image size which can be set by the image size tab 306 on the screen 300.

FIG. 4B shows an example of the design pattern 407 corresponding to the defect-circumferential design data 116. The design pattern 407 includes eight line segments 412, 413, 414, 415, 416, 417, 418 and 419. The line segment 412 is defined by X and Y coordinates of a start point P1 and those of an end point P2. The line segment 413 subsequent to the line segment 412 is defined by X and Y coordinates of a start point P2 and those of an end point P3. That the line segment 413 is continuous from the line segment 412 can be determined from the fact that both the end point of the line segment 412 and the start point of the line segment 413 are at the same point P2. The design pattern 407 further goes likewise through points P3, P4, P5, P6, P7, the origin 411 and returns to point P1. The inside of the closed curve thus formed is defined as a “line” and the outside of the closed curve is defined as a “space”, for example.

In FIG. 4A, the values for the X and Y coordinates are defined by distances from the origin 401 for the design data. In order that the defect review system 108a can handle the defect-circumferential design data 116 like the design data, the defect-circumferential design data 116 are translated to data defined under a new coordinate system as shown in FIG. 4B in which the origin 411 is newly established within the design pattern 407. This translation is accomplished by the data management equipment 100.

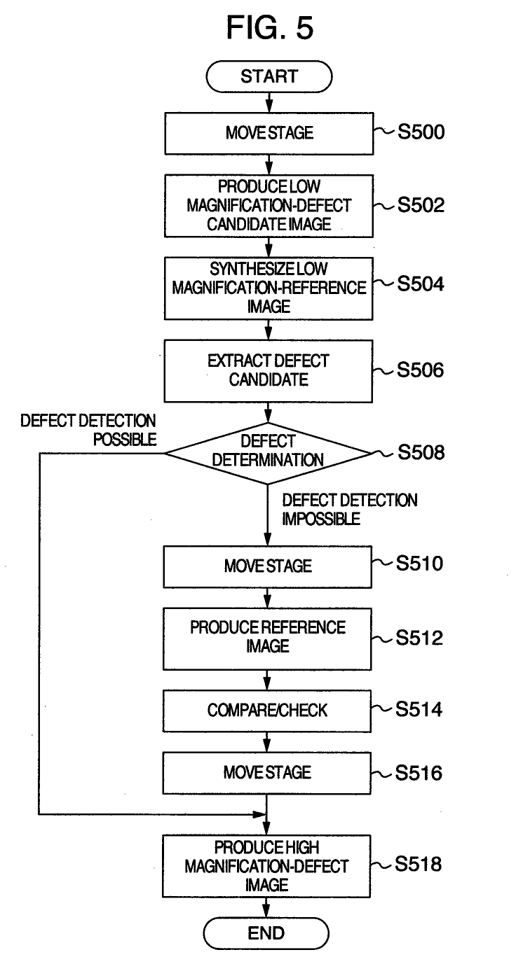

FIG. 5 shows, as a comparison example, a flow chart illustrating a defect detecting method carried out in a defect review system 108a without using the design data. This defect detecting method is described in JP-A-2007-40910 mentioned above.

First, a defect candidate location of a defect candidate is read out from a defect candidate information 118 detected in the inspection system 104a and a stage is moved to the defect candidate location (step S500).

After the movement of the stage, a semiconductor wafer is imaged, in which the imaging is performed at a low magnification to broaden the field of view so that a defect candidate required to be observed is surely within the field of view and that the defect candidate appears on the defect candidate image (step S502). This defect candidate image produced at a low magnification is called a low magnification-defect image.

An image corresponding to a reference image obtained by imaging that part of the semiconductor wafer which is defect-free is produced by removing that part of the low magnification-defect image which appears to be a defect candidate from the low magnification-defect image. This reference image is called a synthesized reference image (step S504).

Next, a defect candidate extraction is performed to obtain a difference between the low magnification-defect image and the synthesized reference image (step S506).

A defect determination is performed to determine whether the defect as obtained from the difference is a true defect or not (step S508).

If it is determined that the defect is true (detect detection possible in step S508), a refocusing is performed on the defect location of the true defect obtained in step S508, and thereafter, the magnification is changed over to a high value and the true defect is imaged (step S518). This defect image of the defect produced at a high magnification is called a high magnification-defect image.

If it is not determined that the defect is true (defect detection impossible in step S508), the stage is moved to an adjacent chip (step S510).

At the adjacent chip, an imaging is performed at a low magnification, and the image so produced is made a reference image (step S512).

The low magnification-defect image is compared/checked with this reference image to specify a defect location of a true defect (step S514).

The stage is moved to the defect location of the true defect in the former chip determined in step S514 (step S516).

A focusing is performed on the defect location of the true defect, and thereafter, the magnification is changed over to a high value and the true defect is imaged to provide a high magnification-defect image (step S518).

According to the defect detecting method in the above-described comparison example, if a defect detection is impossible in the defect determination in step S508, stage movement is performed in steps S510 and S516. Since the stage movement needs a long time, the defect detection method itself may be considered to take a long time.

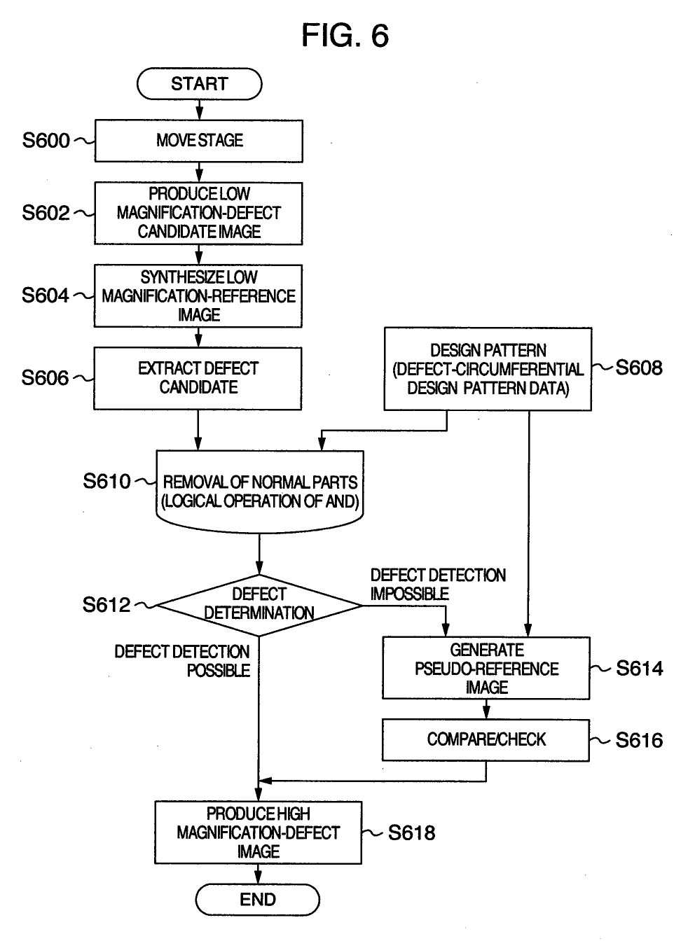

FIG. 6 is a flow chart illustrating a defect detecting method employed in a defect review system 108a included in a testing system 10 according to an embodiment of the present invention.

First, a defect candidate location of a defect candidate is read out from the defect candidate information 118 detected in the inspection system 104a and a stage is moved to the defect candidate location (step S600).

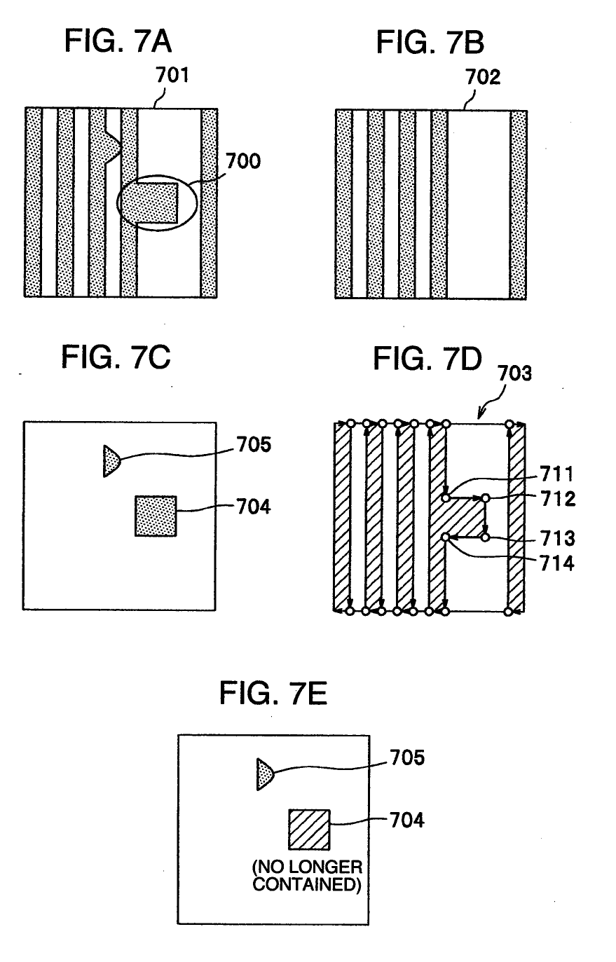

After the movement of the stage, a semiconductor wafer is imaged at a low magnification to acquire, for example, a low magnification-defect image (a defect candidate image) 701 such as shown in FIG. 7A (step S602). It is assumed that the low magnification-defect image 701 contains a recurrent pattern having therein a pattern part with a bent or curved portion 700.

An image corresponding to a reference image to be obtained by imaging a defect-free part of the wafer is produced by removing that part of the low magnification-defect image which appears to be a defect candidate from the low magnification-defect image. The produced image may be a synthesized reference image 702 such as shown in FIG. 7B (step S604).

A difference between the low magnification-defect image and the synthesized reference image is obtained to extract a defect candidate such as shown in FIG. 7C (step S606). As can be seen, in addition to a defect candidate 705, a bent or curved portion 704 is also extracted. The bent or curved portion 704 is a portion of a normal pattern part, and is not a defect candidate. Incidentally, steps S600 to S606 may be identical with steps S500 to S506 in the comparison example.

Before a defect determination (step S612), by using a design pattern 608 (corresponding to design pattern 407 in FIG. 4A) produced from a defect-circumferential design data 116 sent from the data management equipment 100, a step of removal of normal parts of the pattern is accomplished to exclude areas which should not be determined to be defects (or defect candidates) from what is to be subjected to the defect determination (step S610). FIG. 7D shows a design pattern 703 (corresponding to the design pattern 608 in FIG. 6). Symbols O in the design pattern 703 represent start and end points of line segments forming the pattern. The pattern corresponding to the bent or curved portion 704 is formed by the line segments having start and end points at points 711 to 714.

For the step of removal of normal parts of the pattern (normal part removal step), use may be made of a logical operation of AND between the low magnification-defect image and the design pattern 407 (FIG. 4B) produced from the defect-circumferential design data 116. Namely, a logical operation of AND is accomplished between the low magnification-defect image 701 shown in FIG. 7A and the design pattern 703 shown in FIG. 7D so that those parts which result in coincidence are removed. As a result, as shown in FIG. 7E, the bent or curved portion 704 disappears with the defect candidate 705 only left. Thus, owing to the normal part removal step (step S610), the bent or curved portion 704 is now considered to belong to an area which should not be determined to be a defect (or a defect candidate).

The defect candidate which has not been excluded in the normal part removal step is subjected to a defect determination to determine whether it is a true defect or not (step S612). Since the bent or curved portion 704 has been removed, the possibility that the defect detection is impossible is considerably decreased. This will lead to suppression of failures that the defect review system erroneously recognizes a normal pattern part as a defect to image such normal pattern to produce a high magnification-defect image on which, actually, no defect exists.

If it is determined that the defect is true (detect detection possible in step S612), a refocusing is performed on the defect location of the true defect, and thereafter, the magnification is changed over to a high value and the true defect is imaged (step S618). This defect image of the defect produced at a high magnification is called a high magnification-defect image.

If it is not determined that the defect is true (defect detection impossible in step S612), a pseudo-reference image generation is carried out in which a reference image is pseudonymously generated from the design pattern 608 which is produced from the defect-circumferential design data 116 (step S614).

The low magnification-defect image is compared/checked with the pseudo-reference image (step S616).

A refocusing is performed on the defect location of the true defect detected in the compare/check, and thereafter, a high magnification-defect image is produced (step S618).

In the defect detecting method according to the described embodiment, the defect detection does not take a long time because the stage need not be moved many times. Further, the defect detecting method according to the embodiment makes use of design pattern 608 produced from the defect-circumferential design data 116 thereby to facilitate detection of defects (or defect candidates) to specify the locations of defects (or defect candidates). In this connection, the defect-circumferential design data 116 is produced and provided with the data management equipment 100 in advance. Thus, the time for extraction of the defect-circumferential design data 116 from the design data of the semiconductor circuit can be saved.

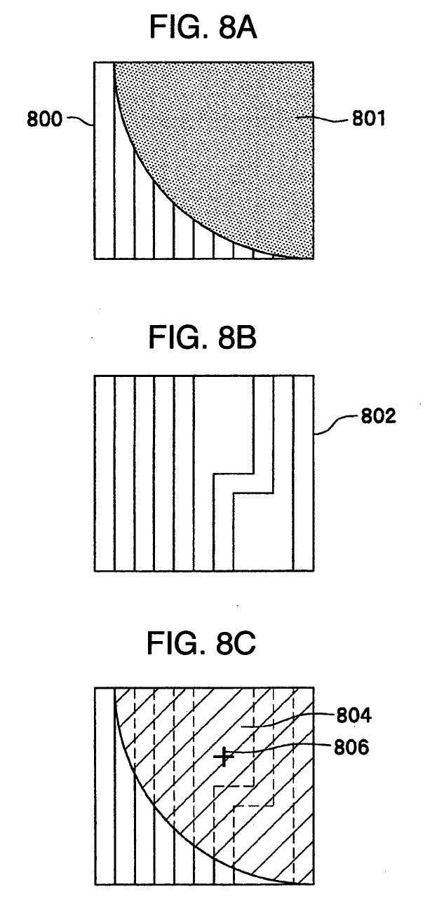

When an image containing a large defect 801 is produced as shown in FIG. 8A, since it is difficult to read the pattern, the defect determination in step S612 in FIG. 6 will result in “defect detection impossible”. It will now be described that the defect detection method according to the embodiment of FIG. 6 is still effective even in such a case.

FIG. 8B shows a pseudo-reference image 802 produced from the design pattern 608. The pseudo-reference image 802 has only to be of a nature capable of the pattern matching with the low magnification-defect image (defect candidate image) 800 shown in FIG. 8A, and therefore, basically, it may be the design data 608 itself. It is understood that the defect review system 108a is expected to image a defect at a high magnification. The low magnification-defect image 800 is compared with the pseudo-reference image 802 (step S616) to recognize a pattern concealed area 804 with which the pattern matching is impossible as shown in FIG. 8C, so that a high magnification-defect image should be produced with the center of gravity 806 of the area 804 being utilized as a location of a true defect (step S618).

With the detecting method according to the embodiment of FIG. 6, even when the semiconductor circuit is a logic circuit such as a CPU so that a low magnification-defect image contains only a small the number of recurrent pattern parts, which may result in “defect determination impossible” in step S612, a pseudo-reference image is produced (step S614), without moving the stage as in the comparison example shown in FIG. 5, for comparison/check with respect to the low magnification-defect image (step S616). Accordingly, defect testing can be achieved in a short time.

Description will next be made of the automatic changeover between C/D described with reference to FIG. 3D. Generally, there exist two check modes for detecting defects in the defect review system 108a, a die-to-die comparison mode and a cell comparison mode.

In the die-to-die comparison mode, a low magnification-defect image containing a defect and a defect-free reference image of an adjacent chip are produced, and then, a difference image is produced by obtaining a difference between the low magnification-defect image and the defect-free reference image. A correct location of a defect (or a defect candidate) is specified by using that difference image.

In the cell comparison mode, when a semiconductor circuit includes a pattern having a recurrence of identical pattern parts like in a semiconductor memory, a reference image is not produced for each low magnification-defect image for the purpose of reducing the testing time; namely, once a reference image is produced, it is repetitively used for obtaining a difference from each low magnification-defect image to produce a difference image, as far as identical patterns are comparison-checked. Correct locations of defects (or a defect candidate) are specified by using the difference image thus produced.

Generally, instructions as to which one of the die-to-die comparison mode and the cell comparison mode should be followed for the defect detection is given by the operator to the defect review system 108a. It is usual that the operator confirms patterns formed on a semiconductor wafer to be tested and confirms information representing the ID of a lot of wafers and manufacturing steps or read such information by means of a reader, and selects one of the comparison modes by rote.

To test a semiconductor wafer, one of the two comparison modes, the die-to-die comparison mode and the cell comparison mode, is followed as designated by the operator, irrespective of in what shape the pattern containing a defect is. Consequently, it would be possible that, when a defect is such that could be dealt with by the cell comparison mode in a short time, the operator might select the die-to-die comparison mode, while, on the contrary, when a defect is such that could not be correctly detected by the cell comparison mode, the operator might select the cell comparison mode.

According to the described embodiment, for the check mode by which the defect review system 108a operates to detect a defect, the selecting unit 6 of the data management equipment 100 (refer to FIG. 1B) performs an automatic switchover between the die-to-die comparison mode and the cell comparison mode on the basis of the defect-circumferential design data, thereby selecting one of the two comparison modes.

In one embodiment of the present invention, on the basis of the defect-circumferential design data, determination that the design pattern contains a recurrence of pattern parts and determination that the design pattern does not contain a recurrence of pattern parts are not both performed, but, rather, it is only determined that a design pattern basically contains a recurrence of pattern parts. Therefore, when the recurrence of pattern parts is not detected, it is concluded thereby that the design pattern does not contain a recurrence. There will be two key factors for determining a recurrence: one is that the pattern parts have an identical shape, and the other is that pattern parts are recurrent with a fixed period (with a periodicity).

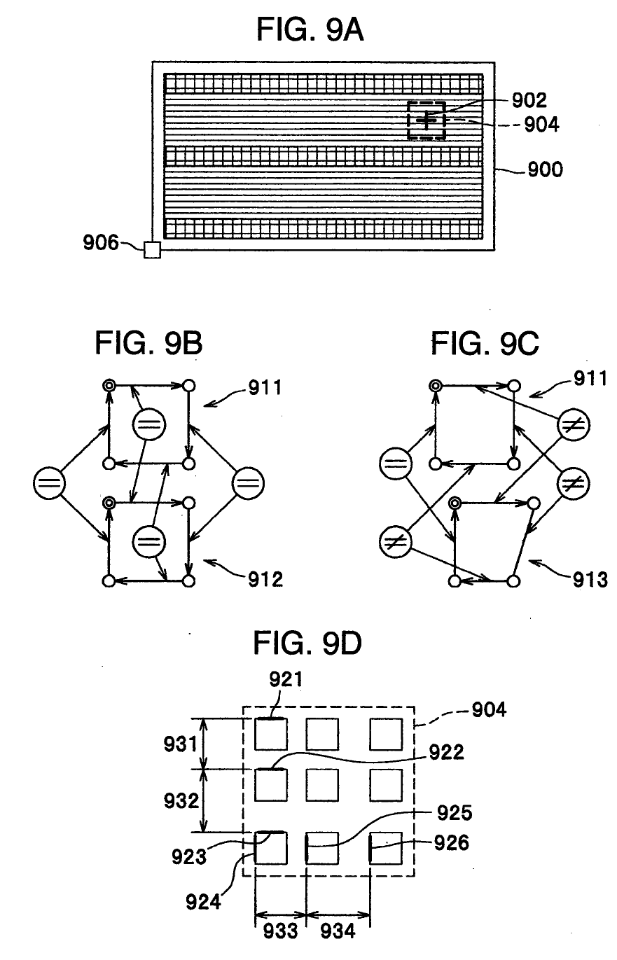

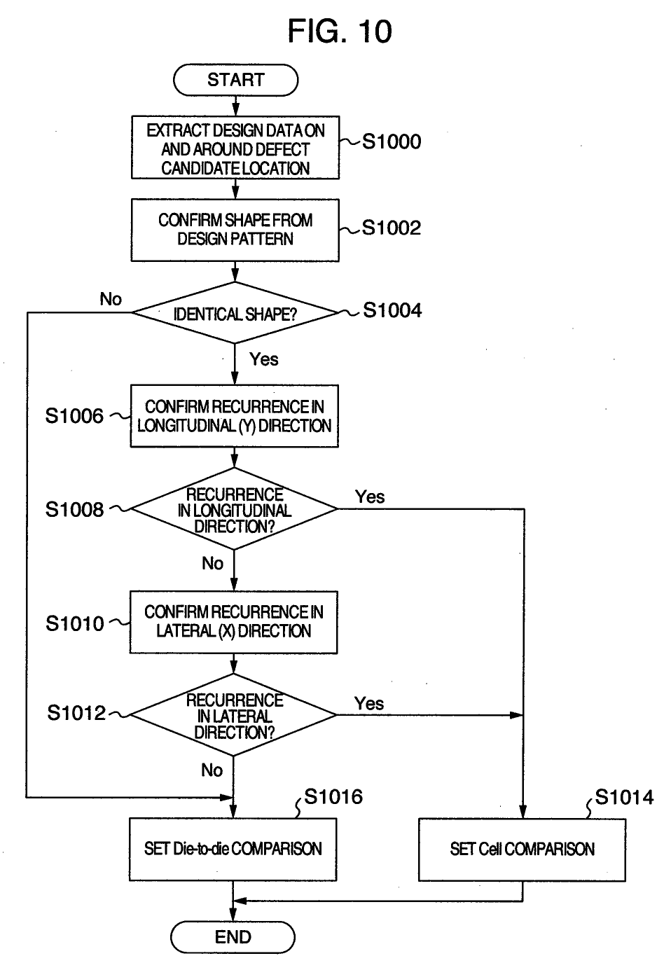

Referring to FIG. 9A showing a design pattern (design data) 900 for a semiconductor circuit, a defect candidate location 902 is acquired with respect to the origin 906. A defect-circumferential defect design data corresponding to a design pattern 904 which contains at its center the defect candidate location 902 is extracted (step S1000 in FIG. 10).

FIGS. 9B and 9C show examples of pattern parts of a portion of a design data and illustrate how to extract pattern parts having an identical shape. The design data is represented by line segments, and the coordinates of the start and end points of the line segments may be expressed in the form of relative coordinates having the origin 906 on the semiconductor device 900.

FIG. 9B shows, as an example, rectangles of an identical shape formed by line segments. A pattern part 911 and a pattern part 912 have an identical shape. It is confirmed that they have line segments corresponding to each other and that the constituent line segments forming the respectively corresponding sides have an identical length and are in the same directions (step S1002). In this example, it is determined that the pattern parts have an identical shape (Yes in step S1004).

FIG. 9C shows, as an example, quadrilaterals of different shapes formed by line segments. Both a pattern part 911 and a pattern part 912 are four-sided and have segments corresponding to each other. It is confirmed that all of the constituent line segments forming the respectively corresponding sides do not have an identical length and are not in the same directions (S1002). In this example, it is determined that the pattern parts have different shapes (No in step S1004).

Determination is performed for all of the pattern parts within the design pattern 904 as to whether they have shapes identical with one another.

FIG. 9D schematically shows the design pattern 904 and illustrates how to determine a recurrence in a design pattern. In the figure, it is assumed that square pattern parts are provided side by side.

First, it is confirmed that a distance 931 between a line segment 921 and a line segment 922 and a distance 932 between a line segment 922 and a line segment 923 are equal to each other. Through this confirmation, a recurrence in the longitudinal direction is confirmed (step S1006).

If a recurrence exists (Yes in step S1008), the process proceeds to step S1014 in which the cell comparison is set for the check mode in the defect candidate information 310 of FIG. 3E for checking the defect candidate existing at the defect candidate location 902. If a recurrence does not exist (No in step S1008), the process proceeds to step S1010.

Next, it is confirmed that a distance 933 between a line segment 924 and a line segment 925 and a distance 934 between a line segment 925 and a line segment 926 are equal to each other. Through this confirmation, a recurrence in the lateral direction is confirmed (step S1010).

If a recurrence exists (Yes in step S1012), the process proceeds to step S1014 in which the cell comparison is set for the check mode for checking the defect candidate existing at the defect candidate location 902. If a recurrence does not exist (No in step S1012), the process proceeds to step S1016. In step S1016, in consideration of the fact that there exists no recurrence, the die-to-die comparison is set for the check mode in the defect candidate information 310 for checking the defect candidate existing at the defect candidate location 902.

As described above, in the described embodiments, the most efficient comparison method is automatically set for the check mode for detecting a defect, which alleviates the work load of the operator and reduces the work time, that is, an efficient testing system can be employed for each defect candidate, the embodiments enjoy a high precision in the defect checking.

It should be further understood by those skilled in the art that although the foregoing description has been made on embodiments of the invention, the invention is not limited thereto and various changes and modifications may be made without departing from the spirit of the invention and the scope of the appended claims.

1. A data management equipment connected with
a general inspection system for detecting a plurality of defect candidates on a wafer or an exposure mask used for manufacturing a semiconductor circuit and acquiring locations at which said defect candidates are located,
a design data server for storing therein design data for the semiconductor circuit and
a defect review system for imaging said defect candidates by using said locations to acquire defect candidate images and for comparing said defect candidate images with defect-free reference images to identify defects,
the data management equipment comprising:
a first detecting unit for finding that said general inspection system is acquiring said locations of said defect candidates;
a storage controlling unit responsive to the finding by said first detecting unit to start to store said locations from said general inspection system in a storage unit; and
defect-circumferential design data acquiring unit for acquiring defect-circumferential design data from portions of said design data, said defect-circumferential design data being such that said reference images can be produced from said defect-circumferential design data, said produced reference images containing said locations, said storage controlling unit serving to store said defect-circumferential design data in said storage unit in such a manner that said defect-circumferential design data are related to corresponding locations for each defect candidate.

2. A data management equipment according to claim 1, wherein
said storage controlling unit reads out said defect-circumferential data and said locations to said defect review system, and
said defect review system acquires said reference images by using said defect-circumferential design data.

3. A data management equipment according to claim 1, wherein
said general inspection system acquires sizes of the respective defect candidates, and
said data management equipment further comprises an imaging area deciding unit for deciding areas to be imaged with resect to the defect candidates by using said sizes, said areas to be imaged with respect to the defect candidates being coincident with those areas with which said reference images can be produced.

4. A data management equipment according to claim 1, wherein
said data management equipment further comprises a second detecting unit for finding that said defect review system has captured one of said wafers or one of said exposure masks, and
said storage controlling unit is responsive to the finding by said second detecting unit to start to read out said defect-circumferential design data and said locations to said defect review system from said storage unit.

5. A data management equipment according to claim 1, wherein said data management equipment further comprises a selecting unit for selecting, by using said defect-circumferential design data, one from a group consisting of die-to-die comparison and cell comparison as a check mode by which said defect review system compares said defect candidate images with said reference images.

6. A data management equipment according to claim 5, wherein said selecting unit determines whether said defect-circumferential design data define a plurality of pattern parts of an identical shape and whether said plurality of pattern parts of an identical shape are recurrent with a periodicity.

7. A data management equipment according to claim 1, wherein said storage controlling unit
stores, in said storage unit, said locations of said defect candidates on said plurality of wafers or exposure masks from said general inspection system, and
reads out, from the storage unit to said defect review system, said locations of said defect candidates for each of wafers or exposure masks having been captured.

8. A testing system comprising:
a general inspection system for detecting a plurality of defect candidates on a wafer or an exposure mask used for manufacturing a semiconductor circuit and acquiring locations at which said defect candidates are located;
a design data server for storing therein design data for the semiconductor circuit; and
a defect review system for imaging said defect candidates by using said locations to acquire defect candidate images and for comparing said defect candidate images with defect-free reference images to identify defects, wherein
the testing system further comprises a data management equipment including:
a detecting unit for finding that said general inspection system is acquiring said locations of said defect candidates;
a storage controlling unit responsive to the finding by said detecting unit to start to store said locations from said general inspection system in a storage unit; and
a defect-circumferential design data acquiring unit for acquiring defect-circumferential design data from portions of said design data, said defect-circumferential design data being such that said reference images can be produced from said defect-circumferential design data, said produced reference images containing said locations, said storage controlling unit serving to store said defect-circumferential design data in said storage unit in such a manner that said defect-circumferential design data are related to corresponding locations for each defect candidate.

9. A defect review system connected with
a general inspection system for detecting a plurality of defect candidates on a wafer or an exposure mask used for manufacturing a semiconductor circuit and acquiring locations at which said defect candidates are located and
a design data server for storing therein design data for the semiconductor circuit,
the defect review system serving to image said defect candidates by using said locations to acquire defect candidate images and serving to compare said defect candidate images with defect-free reference images to identify defects, wherein
the defect review system comprises a data management equipment including:
a detecting unit for finding that said general inspection system is acquiring said locations of said defect candidates;
a storage controlling unit responsive to the finding by said detecting unit to start to store said locations from said general inspection system in a storage unit; and
defect-circumferential design data acquiring unit for acquiring defect-circumferential design data from portions of said design data, said defect-circumferential design data being such that said reference images can be produced from said defect-circumferential design data, said produced reference images containing said locations, said storage controlling unit serving to store said defect-circumferential design data in said storage unit in such a manner that said defect-circumferential design data are related to corresponding locations for each defect candidate.
